(19) United States
(12) Patent Application Publication
(10) Pub. No.: US 2011/0195735 A1
(43) Pub. Date: Aug. 11, 2011

(54) Multiple Power Control Parameter Sets for Wireless Uplink Data Transmission

(76) Inventors: Ralf Irmer, Newbury (GB); Bernhard Raaf, Neuried (DE); Ingo Viering, Munich (DE)

(21) Appl. No.: 13/060,326

(22) PCT Filed: Aug. 27, 2008
(86) PCT No.: PCT/EP2008/061236

§ 371 Date: Apr. 25, 2011

(51) Int. Cl. H04W 52/04; H04W 72/04

(52) U.S. Cl. 455/509; 455/522

(57) ABSTRACT

It is described a method for controlling the transmission power for a network element being connected to a base station of a cellular telecommunication network via an uplink wireless data connection. The method including providing a first set (set1) of power control parameters (P₀_{_{—}}_{PUSCH}_{_{—}}₁, α₁) and a second set (set2) of power control parameters (P₀_{_{—}}_{PUSCH}_{_{—}}₂, α₂), storing the first set (set1) of power control parameters (P₀_{_{—}}_{PUSCH}_{_{—}}₁, α₁) and the second set (set2) of power control parameters (P₀_{_{—}}_{PUSCH}_{_{—}}₂, α₂) within the network element, using the first set (set1) of power control parameters (P₀_{_{—}}_{PUSCH}_{_{—}}₂, α₁) by the network element for transmitting within a first radio transmission resource, and using the second set (set2) of power control parameters (P₀_{_{—}}_{PUSCH}_{_{—}}₂, α₂) by the network element for transmitting within a second radio transmission resource. Further, it is described a network element and a base station, which are, in connection with each other, adapted to carry out the described transmission power controlling method.

### FIELD OF INVENTION

The present invention relates to the field of operating cellular telecommunication networks. In particular, the present invention relates to a method for controlling the transmission power for a network element being connected to a base station of a cellular telecommunication network via an uplink wireless connection. Further, the present invention relates to a network element and to a base station, which are, in connection with each other, adapted to carry out the described transmission power controlling method. Furthermore, the present invention relates to a computer program, which, when executed by means of a processor, is adapted to carry out the described transmission power controlling method.

### ART BACKGROUND

Uplink power control is a mandatory feature for every multiple access telecommunication system which is not based purely on the principles of Time Division Multiple Access (TDMA). The reason is that the radio signals being transmitted by different User Equipments (UE) are typically not ideally orthogonal. This is quite obvious for the Wideband Code Division Multiple Access (WCDMA) technology, wherein the signals from different UEs are separated by quasi-orthogonal spreading codes. This leads at least to some significant intra-cell interference. However, also in a telecommunication network operating with Orthogonal Frequency Division Multiple Access (OFDMA) the signals being transmitted from different UEs are not ideally separated because of physical and/or technical limitations, which cannot be avoided. Such limitations are for instance (a) the Doppler Effect, if the corresponding UE is moving relative to its serving base station, (b) a non-ideal synchronization of local oscillators of the different UE, (c) non linearities within the radio signal transmission and/or the radio signal reception and/or (d) a limited resolution of analog-to-digital conversion procedures.

These limitations lead to the fact that there is always at least some leakage from one UE's radio signal to another UE's radio signal. This leakage limits the dynamic range of a base station's receiver structure. In other words, the receiver structure cannot resolve different signals from each other which exhibit large differences in receive level.

Generally speaking, without a proper power control, i.e. all the UEs would transmit with the same (maximum) signal power, the received level of a UE, which is situated close to the base station, would be significantly larger than that of a UE, which is situated from far away from the base station. Due to the above described leakage, it would not be possible to resolve the weak signal from the far UE from the strong signal from the close UE. Descriptively speaking, the weak signal from the far UE would drown in the strong signal from the close UE.

It order to allow for a signal reception quality, which is distributed equally between different UEs, it is known that the corresponding telecommunication network can take care somehow that the base station receives the signals being transmitted from all UEs within the corresponding cell of the telecommunication network with at least a similar power. Thereby, the received dynamics have to be within the previously mentioned leakage.

However, this means that the resulting Signal to Noise Ratio (SNR) or the resulting Signal to Interference and Noise Ratio (SINR) have to be similar for different UE being assigned to one particular cell. In that case also the achievable data rates for radio transmissions between the base station and the respective UE will be similar. However, this has the consequence that UE being currently situated close to the base station do not really benefit from the fact that they have a very small pathloss and probably do not cause interference to the other cells. Therefore, the peak performance for an overall radio data transmission within the cell is more or less determined by the UE which have the worst radio connection to the base station. Specifically, for UEs being located close to the base station it is not allowed that their receive signal intensity (Rx level) significantly exceeds the Rx level of the UE being located far away from the base station.

This limitation is in particular harmful, if features and/or extensions of the cellular telecommunication network are based on a very high data rate. This is the case for instance for effectively extending the spatial coverage of modern Long Term Evolution (LTE) networks by means of using one or more Relay Nodes for an enhanced NodeB representing a base station for a LTE telecommunication network.

In this respect it is pointed out that relaying is based on the fact, that the link between the base station and the Relay Node is a very good link, which is significantly better than other direct links between UEs and the base station. However, a high data rate is needed without consuming too much data transmission resources from the telecommunication network, because the base station has to “backhaul” data traffic being associated with the Relay Nodes. Due to the power control restrictions elucidated above, the good radio transmission channel conditions on the radio link between base station and relay node cannot be fully exploited. Accordingly, similarly to UEs being located close to the base station also Relay Nodes are not able to realize high data rates with the base station.

In order to improve the performance for high quality radio links the standard specifications for LTE telecommunication networks define a power control with a “fractional pathloss compensation”. This is in contrast to a “full pathloss compensation”, wherein the pathloss is supposed to be completely compensated by adapting the radio transmitting power such that all UEs are received by the base station with the same reception power. The “fractional pathloss compensation” means that close UEs are received with a slightly higher reception power than the UEs being located far away from the base station. This allows at least to some extent to achieve higher SINRs for the close UE users. Thereby, the transmitting power P_{PUSCH} for a UE is described by the following equation (1):

P_{PUSCH}=min{P_{MAX},10 log₁₀M_{PUSCH}+P_{O}_{_{—}}_{PUSCH}+α·PL+Δ_{TF}(TF)+f} (1)

Thereby, P_{MAX} is the maximum transmitting power of the respective UE, i.e. the UE cannot transmit with a higher power. The second expression in the curly brackets represents the target value for the UE's transmitting power.

Within the second expression in the curly brackets M_{PUSCH} represents the number of Physical Resource Blocks (PRBs), which are assigned to the respective radio data link. The other terms of the target value represent power control values respectively for one PRB. P₀_{_{—}}_{PUSCH} and α are the above described power control settings, wherein P₀_{_{—}}_{PUSCH} represents a reference transmitting power and α represents the slope for a “fractional pathloss compensation”. PL is the pathloss, which is estimated by the respective UE from downlink (DL) measurements. The terms “Δ(TF)” and “f” are used for a fine tuning of the transmitting power P_{PUSCH} for instance with respect to a current spectral efficiency (the higher the spectral efficiency is the higher is the transmitting power) and with respect to a currently used modulation coding scheme. Since for the invention described in this application this fine tuning is not relevant here, it will not be described in further detail.

The case of “full pathloss compensation” is included in this formula as α=1. The extreme case β=0 would correspond to not taking into account pathloss for the control of the transmitting power P_{PUSCH}. In practice, typical values for α are around 0.6. The smaller the value for α is, (a) the higher are the SINRs for the close UEs and (b) the worse is the leakage problem. This is the crucial trade off in the above described current power control.

There may be a need for improving the power control procedures for user equipments being served by a base station of a cellular telecommunication network in such a manner, that in particular for user equipments being located close to the base station a high Signal to Noise ratios can be achieved while consuming only low data transmission resources.

### SUMMARY OF THE INVENTION

This need may be met by the subject matter according to the independent claims. Advantageous embodiments of the present invention are described by the dependent claims.

According to a first aspect of the invention there is provided a method for controlling the transmission power for a network element being connected to a base station of a cellular telecommunication network via an uplink wireless data connection. The provided method comprises (a) providing a first set of power control parameters and a second set of power control parameters, (b) storing the first set of power control parameters and the second set of power control parameters within the network element, (c) using the first set of power control parameters by the network element for transmitting within a first radio transmission resource, and (d) using the second set of power control parameters by the network element for transmitting within a second radio transmission resource.

The described transmission power controlling method is based on the idea that by configuring more than one cell-specific set of power control parameters the transmission power control within a cell comprising a plurality of user equipments (UE) can be addressed specifically depending on the current operating condition within one cell of the telecommunication network.

In particular, by allowing one and the same UE to select one set out of at least two sets of power control parameters for transmitting uplink to the base station, a “strong UE” having a high quality radio data connection to the base station can obtain the capability to be considerate of the situation of a “weak UE” having a poor quality radio data connection to the base station. This may mean that the “strong UE” can use the less aggressive set of power control parameters for transmitting its uplink (UL) signals with a smaller transmitting power as compared to a situation without the weak UE being present.

In this respect an aggressive set of power control parameters may be characterized by transmitting as powerful as possible and not caring much about compensating the pathloss of radio signals propagating from the transmitting network element to the receiving base station. That means that UEs that experience a high pathloss cannot maintain an as high reception power at the base station as UEs experiencing only a small pathloss. Accordingly, a non aggressive set of power control parameters is characterized by compensating the pathloss fully and not allowing to transmit with high power in low pathloss situations.

The described method may provide the advantage that the performance of a very strong UE and in particular the performance of Relay Nodes can be enhanced significantly without discriminating or penalizing weak (far away) UEs. This benefit of the described transmission power controlling method has been proven by the inventors by using appropriate emulators for the overall performance of a cellular telecommunication network.

The network element may be any entity which is adapted to connect to the base station by means of a wireless data transmission link. In particular, the network element may be a Relay node or a user equipment (UE). The UE may be any type of communication end device. In particular the UE may be a cellular mobile phone, a Personal Digital Assistant (PDA), a notebook computer and/or any other movable communication device.

According to an embodiment of the invention the first set and/or the second set is a predefined set of power control parameters. This may provide the advantage that the respective predefined set can stored within a network element, which participates in the described data transmission in the uplink wireless data connection. If the network element being involved in the data transmission has stored the different sets of control parameters within a memory, the base station can effectively inform this network element which of the stored sets of control parameters should be used. In principle only one single bit is necessary for such a signaling of the control parameter sets, which are supposed to be used. In other words, by using only a minimum signaling overhead a plurality of network elements may be informed by the base station which set out of two sets of power control parameters should be used for appropriately selecting the appropriate transmitting power.

According to a further embodiment of the invention the first set of power control parameters and/or the second set of power control parameters includes a value being indicative for the signal power offset received by the base station. The described signal power offset being received by the base station can also be called a target received power, which can directly be controlled by carrying out the described method.

According to a further embodiment of the invention the first set and/or the second set of power control parameters includes a slope parameter for a fractional pathloss compensation. This may provide the advantage that the extent to which a pathloss is compensated can be directly adjusted by selecting an appropriate value for the described slope parameter.

In this respect it is mentioned that a pathloss occurs due to the attenuation of a radio signal along its way propagating from the sender i.e. the network element to the receiver i.e. the base station. The overall attenuation of course strongly depends on the spatial distance between the sender and the receiver. Further, the attenuation of course also depends on the possible presence of barriers such as for example buildings, which are present within the propagation path of the radio signal extending between the sender and the receiver.

It has to be mentioned that the set of power control parameters may also contain an offset value, which is to be added to at least one of the normally applicable parameters such as the above described signal power being received by the base station and/or the slope parameter for a fractional pathloss compensation. Deriving a second set from the first set by applying an offset has the advantage that typically less bits need to be providing for signaling the second set.

According to a further embodiment of the invention the first radio transmission resource is a first time slot and/or the second radio transmission resource is a second time slot.

If the transmission power of not only one network element but of a plurality of network elements is controlled by the described method, in every transmission time interval (TTI) only one single set of parameters is allowed (or configured) to be used by all the network elements, which are scheduled in the corresponding TTI. This may provide the advantage that interference effects between the signals origination from different network elements, in particular interference effects between strong and weak network elements, can be kept within very small and acceptable limits.

The time slot may result from any division or subdivision of the time axis. In particular the time slot may be denominated a time transmission interval (TTI). Other alternatives include subframe, radio frame or also a collection of several of any of these time intervals.

It has to be mentioned that the described assignment of sets of power control parameters to certain TTIs may be coordinated (i.e. aligned) between neighboring cells. This may provide the advantage that inter cell interference effects can be reduced significantly.

Generally speaking, according to an embodiment of the invention there might be a fixed and/or predetermined allocation of TTIs to the different sets of power control parameters. Thereby, (A) the power control parameter sets may be assigned cyclically to the TTIs or (B) the power control parameter set to be used may be respectively signaled to the scheduled network elements for each TTI or for certain TTIs.

Specifically, in the first case (A) a possible algorithm may comprise the following steps: (a) Assume there are n_set different sets of power control parameters, (b) assign a TTI number “n_TTI” to each TTI, (c) calculate k_set=n_TTI mod N, and (d) apply the parameter set number setv(k_set), wherein setv(0), setv(1), . . . setv(N−1) is a vector indicating which set of power control parameters is to be used (i.e. each setv(i) is an element of {0, 1, . . . n_set−1}. Thereby, a special case is to simply cycle through the sets, i.e. use simply the set n_TTI mod N. In this case N=n_set has to be selected.

Specifically, the second case (B) is similar to a power offset that can be signaled to the network elements. However, instead of signaling a power offset an indication of the used set is signaled. Thereby, for signaling the signaling field now allocated for the power offset can be reused. It should be noted that it is not necessary that the power difference that results from applying the first set or the second set is always the same. The power difference may also depend on the pathloss as well. If the pathloss is supposed to be signaled via power offsets, then several different power offsets would have to be signaled. In this case the signaling being necessary is therefore much more compact and efficient.

According to a further embodiment of the invention the transmission power for a plurality of network elements being assigned to a cell of the cellular telecommunication network is controlled. Further, (a) the first set of power control parameters is used by the plurality of network elements for transmitting within the first radio transmission resource and (b) the second set of power control parameters is used by the plurality of network elements for transmitting within the second radio transmission resource. This may provide the advantage that apart from interference effects between signals being transmitted within different radio transmission resource blocks there is no signal disturbance at the base station. In particular, radio signals originating from “strong” network elements being located close to the base station may be received from the base station with a much higher signal intensity than radio signals originating from “weak” network elements being located comparatively far away from the base station. The higher the separation between the different radio transmission resource blocks is, the smaller are undesirable so called inter resource block interference effects.

In this respect it is mentioned that for transmitting data via a radio link a sufficient data transmission resource has to be provided. Typically, the overall data transmission resource is subdivided in minimum transmission resource units for the data transfer. This minimum unit may be called a radio transmission resource block, a physical resource block (PRB), a chunk, a slot and/or a frame. The minimum unit may be illustrated as a two-dimensional element within a coordinate system having a time-axis and a frequency-axis.

Generally speaking, according to the described embodiment within one radio transmission resource the plurality of network elements may collectively use only one of the first set and the second set of power control parameters. Thereby, the first and/or the second radio transmission resource may comprise one or more radio transmission blocks. Thereby, also within a specific set of different radio transmission resource blocks the plurality of network elements may only be allowed to use a specific set of power control parameters.

It is pointed out that with respect to the need of (a) a preferable individual adaptivity of the transmission power control for all transmitting network elements and (b) requiring a small signaling overhead only, the described method represents a very good compromise. In particular, the described method is different (a) from a transmission power control being completely specific for each network-element and (b) from a power control being completely cell-specific.

According to a further embodiment of the invention the step of providing the first set of power control parameters and the second set of power control parameters comprises signaling the first set and/or the second set of power control parameters to the plurality of network elements on a common radio channel. This may provide the advantage that the signaling overhead can be significantly reduced, which overhead is necessary in order to provide the plurality of network elements with the information being indicative for the appropriate values of the first and/or the second power control parameters sets. The described signaling can be accomplished for instance by means of a broadcasting procedure, wherein a single message being indicative for the first and/or the second power control parameter sets is received by all affected network elements. As has been described already above the plurality of network elements may comprise any combination user equipments and/or relay nodes.

According to a further embodiment of the invention, in answer to a change of a condition for transmitting radio signals (a) a usage of the first set of power control parameters is associated with a first change of the transmitting power of the network element and (b) a usage of the second set of power control parameters is associated with a second change of the transmitting power of the network element. Thereby, the first change is smaller than the second change.

In case of a fractional pathloss compensation this could be achieved for instance by associating an aggressive pair of power control parameters with the first set and a more conservative pair of power control parameters with the second set. Thereby, the aggressive pair of power control parameters may comprise a comparatively large value for the parameter P₀_{_{—}}_{PUSCH} of the above described equation (1) representing the reference transmitting power and/or a comparatively small value for the parameter α of the above described equation (1) representing the slope for the fractional pathloss compensation. By contrast thereto the conservative pair of power control parameters may comprise a comparatively small value for the parameter P₀_{_{—PUSCH}} and/or a comparatively large value for the parameter α.

Preferably, the first respectively the aggressive set could be used for even time slots and the second respectively the conservative set of power control parameters could be used for uneven time slots. Thereby, the even and the uneven time slots may be placed on the time scale in an interlaced or interposed manner. Of course, also the first respectively the aggressive set of power control parameters could be used for uneven time slots and the second respectively the conservative set could be used for uneven time slots.

According to a further embodiment of the invention the plurality of network elements comprises a first group of first network elements and a second group of second network elements, wherein each one of the first network elements has a better radio connection with the base station as each one of the second network elements. Further, (a) the first radio transmission resource is allocated predominantly to the first network elements, and (b) the second radio transmission resource is allocated predominantly to the second network elements.

In particular, the first network elements, which are typically located comparatively close to the base station, can be scheduled in first time slots which are associated with the above described aggressive pair of power control parameters. Analogously, the second network elements, which are typically located comparatively far from the base station, can be scheduled in second time slots which are associated with the above described conservative pair of power control parameters. This may mean that within the first time slots the first respectively the strong network elements can increase their transmitting power without being considerate of the second respectively the weak network elements, because the weak network element having a limited transmission power only are presently not scheduled by the base station. Thereby, the first network elements can achieve high SINRs and a high data throughput.

In order to limit interference effects between data signals being associated with at least one of the first network elements and at least one of the second network elements the first radio transmission resource is a first Time Transmission Interval (TTI) and the second radio transmission resource is a second TTI being separated in time from the first TTI.

In other words, during the first TTI all radio signals may be transmitted with a comparatively high transmission power. In order not to disturb second network elements, which are located far away from the base station, the second network elements are not scheduled during the time slots representing the first TTI.

According to a further embodiment of the invention the plurality of network elements comprises a first group of first network elements and a second group of second network elements, wherein each one of the first network elements has a better radio connection with the base station as each one of the second network elements. Further (a) the first radio transmission resource is exclusively allocated to the first network elements and (b) the second radio transmission resource is allocated to all network elements of the plurality of network elements.

This may mean that all network elements, i.e. also these network elements which are typically located comparatively close to the base station, can be scheduled in these TTIs, which are assigned to the conservative setting of the power control parameter. In the following these TTIs will be called second TTIs. By contrast thereto, those TTIs, which are assigned to the first set of power control parameters, will be called first TTIs.

Generally speaking, during the second TTIs there is no danger for the signals being transmitted from the second network elements to drown the signals being transmitted by the first network elements due to the above described leakage problem. Within the second TTIs the strong first network elements (user equipments and/or relay nodes) cannot enjoy high SINRs or high throughput in those TTIs. However, within the second TTIs the strong first network elements can realize an ordinary SINR or a high throughput, which of course is still better than being completely not scheduled within the second TTIs. In other words, within the second TTIs it is not necessary to completely switch off the strong first network elements. Therefore, within the second TTIs the first network elements can at least benefit from a reduced transmission power.

In other words, within the second TTIs the total transmission intensity received by the base station has to be lower. Therefore, the strong (e.g. close) first network elements have to be considerate of weak (e.g. far away) second network elements by dropping their transmission intensity. This results in that the signal originating from the weak second network elements are not drowned in the signals of the strong first network elements.

In this respect it is mentioned that between the different TTIs of a Time Domain Multiple Access (TDMA) system there are no leakage problems as long as there are sufficient guard periods respectively cyclic prefixes in order to provide for a reliable separation between the first TTIs and the second TTIs. More precisely, there are no leakage problems between the last symbol of the first TTI and the first symbol of the second TTI, other symbols are generally not affected. As a consequence, receive (Rx) signals in adjacent TTIs can have a much higher difference than transmit (Tx) signals in adjacent frequency chunks. However, the larger the distance is in frequency domain between chunks, the better the separation is also in frequency domain.

According to a further embodiment of the invention the described transmission power controlling method further comprises (a) providing at least a further set of power control parameters, (b) storing the further set of power control parameters within the network element, and (c) using the further set of power control parameters by the network element for transmitting within a further radio transmission resource.

Using a further set of power control parameters may provide the advantage that the granularity of available power control parameter sets can be increased. Therefore, depending on the current operating conditions of the whole radio network for each network element the most appropriate set of power control parameters can be selected out of at least three different power control parameter sets.

This may be also beneficial, because preferably in one TTI only a single set is used by all scheduled network elements. If there are more than two power control parameter sets available, then it is more likely to find a collection of network elements that can make good use of one power control parameter set when scheduled together. Basically the scheduler needs to assign each network element a power control parameter set in a way that the groups of network elements using the same set can be scheduled together. If there are more groups available there is more freedom to get a good assignment. Note that it is not necessary to use each of the available power control parameter sets all the time, so an un-useful set does not have to be used and then doesn't harm.

In this respect it is pointed out that there is no principal limit for the number of power control parameter sets being provided to and stored in the network element.

According to a further aspect of the invention there is provided a network element for a cellular telecommunication network. The provided network element comprises (a) a memory for storing a first set of power control parameters and a second set of power control parameters, and (b) a transmission unit, which is adapted to use the first set of power control parameters for transmitting within a first radio transmission resource, and to use the second set of power control parameters for transmitting within a second radio transmission resource.

This further aspect of the present invention is based on the idea that depending on current operating conditions within the cell of the telecommunication network, an appropriate set of power control parameters can be used by the network element. Thereby, each set of power control parameters is associated with a certain radio transmission resource.

According to an embodiment of the invention the network element is a user equipment or a relay node of the cellular telecommunication network. This may provide the advantage that the above described transmission power controlling method can be used both for ordinary user equipments such as in particular cellular phones and for relay nodes.

In particular, the possibility to increase the overall performance of a relaying system with respect to the data throughput may represent a great improvement for future Long Term Evolution (LTE) telecommunication networks in order to increase the spatial coverage of LTE network cells.

According to a further aspect of the invention there is provided a base station for a cellular telecommunication network. The provided base station comprises a unit for providing a first set of power control parameters and a second set of power control parameters to at least one network element in such a manner that (a) the first set of power control parameters and the second set of power control parameters are storable within a memory of the network element, (b) the first set of power control parameters is usable by the network element for transmitting within a first radio transmission resource and (c) the second set of power control parameters is usable by the network element for transmitting within a second radio transmission resource.

Also this aspect of the present invention is based on the idea that the described base station may initiate the network element to use different power control parameters for different radio transmission resources. Thereby, the power control parameter sets can be associated in a fixed manner with different radio transmission resources. The radio transmission resources may be in particular a TTI or a time slot representing an elementary unit of a TDMA system.

Together with at least one of the above described network elements the base station may represent a cell of the cellular telecommunication network. The cell may represent a part of a hierarchical network structure, which may include at least one of a Macro Cell, a Micro Cell, Relay Cell and/or a Femto Cell.

According to a further aspect of the invention there is provided a computer program for controlling the transmission power for a network element being connected to a base station of a cellular telecommunication network via an uplink wireless data connection. The computer program, when being executed by a data processor, is adapted for controlling the above described transmission power controlling method.

As used herein, reference to a computer program is intended to be equivalent to a reference to any program element and/or to a computer readable medium containing instructions for controlling a computer system to coordinate the performance of the above described method.

The computer program (element) may be implemented as computer readable instruction code in any suitable programming language, such as, for example, JAVA, C++, and may be stored on a computer-readable medium (removable disk, volatile or non-volatile memory, embedded memory/processor, etc.). The instruction code is operable to program a computer or other programmable device to carry out the intended functions. The computer program may be available from a network, such as the WorldWideWeb, from which it may be downloaded.

The described invention may be realized by means of a computer program respectively software. However, the invention may also be realized by means of one or more specific electronic circuits respectively hardware. Furthermore, the invention may also be realized in a hybrid form, i.e. in a combination of software modules and hardware modules.

It has to be noted that embodiments of the invention have been described with reference to different subject matters. In particular, some embodiments have been described with reference to method type claims whereas other embodiments have been described with reference to apparatus type claims. However, a person skilled in the art will gather from the above and the following description that, unless other notified, in addition to any combination of features belonging to one type of subject matter also any combination between features relating to different subject matters, in particular between features of the method type claims and features of the apparatus type claims is considered as to be disclosed with this application.

The aspects defined above and further aspects of the present invention are apparent from the examples of embodiment to be described hereinafter and are explained with reference to the examples of embodiment. The invention will be described in more detail hereinafter with reference to examples of embodiment but to which the invention is not limited.

### BRIEF DESCRIPTION OF THE DRAWINGS

FIG. 1 shows a cellular telecommunication network comprising a base station and different network elements, which are adapted to accomplish a transmission power controlling method according to an embodiment of the present invention.

FIG. 2 shows a diagram illustration the dependency of the transmitting power of a network element from a pathloss between the network element and the serving base station for two different sets of power control parameters.

FIG. 3 shows a user equipment representing a network element, which is adapted to accomplish a transmission power control in accordance with the present invention.

FIG. 4 shows a base station, which is adapted to prompt a user equipment to accomplish the described transmission power controlling method.

### DETAILED DESCRIPTION

The illustration in the drawing is schematically. It is noted that in different figures, similar or identical elements are provided with the same reference signs or with reference signs, which are different from the corresponding reference signs only within the first digit.

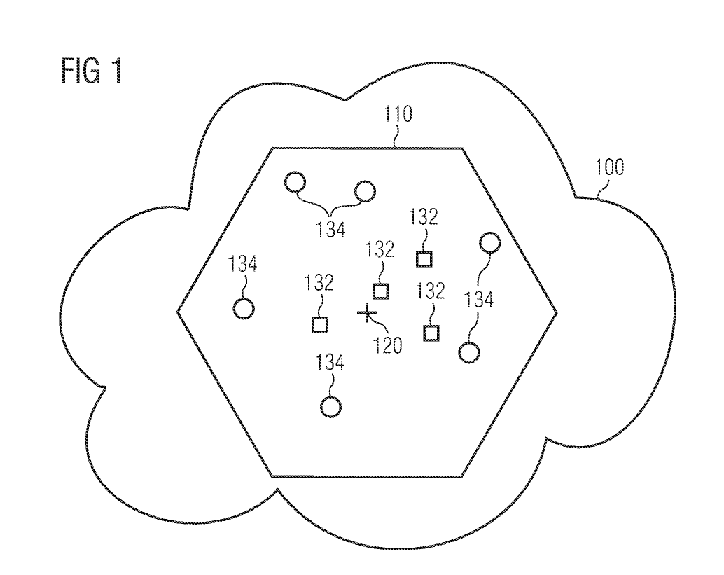

FIG. 1 shows a cellular telecommunication network 100. The cellular telecommunication network 100 comprises a plurality of cells, wherein in FIG. 1 only one cell 110 is depicted for the sake of clarity. The cell 110 is served by a base station 120. In the framework of Universal Mobile Telecommunications System (UMTS) the base station is called a NodeB. In the framework of Long Term Evolution (LTE) networks, the base station is typically called an enhanced NodeB (eNB).

Within the cell 110 there is located a plurality of network elements 132, 134. Each network element 132, 134 may be (a) a user equipment (UE) such as for instance a cellular phone, a personal digital assistant (PDA) or a notebook computer or (b) a relay node, which itself serves other network elements being located with a spatial portion of the cell 110.

The plurality of network elements 132, 134 is subdivided into a first group of first network elements 132 and a second group of second network elements 134. Thereby, each one of the first network elements 132 has a better radio connection with the base station 120 as each one of the second network elements 134. Since the quality of the radio connection between the base station 120 and the respective network element 132, 134 to a large extend depends on the spatial distance between the base station 120 and the respective network element 132, 134, in FIG. 1 the first network elements 132 are located closer to the base station 120 as the second network elements 134. Of course, radio barriers such as buildings, which may be present in the cell 110 and which are not depicted in FIG. 1, may cause that network elements being located comparatively close to the base station 120 would have to be considered as to represent a second network element. This may be caused by a comparatively large attenuation of radio signals propagating between the respective network element and the base station 120.

According to the embodiment described here a first radio transmission resource, which is a set of first Transmission Time Intervals (TTIs), is allocated to the first network elements 132, and a second radio transmission resource, which is a set of second TTIs, is allocated to the second network elements 134. Further, if transmitting within the first TTIs, all network elements 132, 134 use a first set of power control parameters. Correspondingly, if transmitting within the second TTIs, all network elements 132, 134 use a second set of power control parameters. The first and the second set of power control parameters are predetermined parameters. The corresponding values have been provided before to the network elements 132, 134 for instance by the base station 120.

According to the embodiment described here each of the two sets of power control parameters includes (a) the above described parameter P₀_{_{—}}_{PUSCH} being indicative for the signal power received by the base station 120 and (b) the above described parameter α representing the slope for a fractional pathloss compensation.

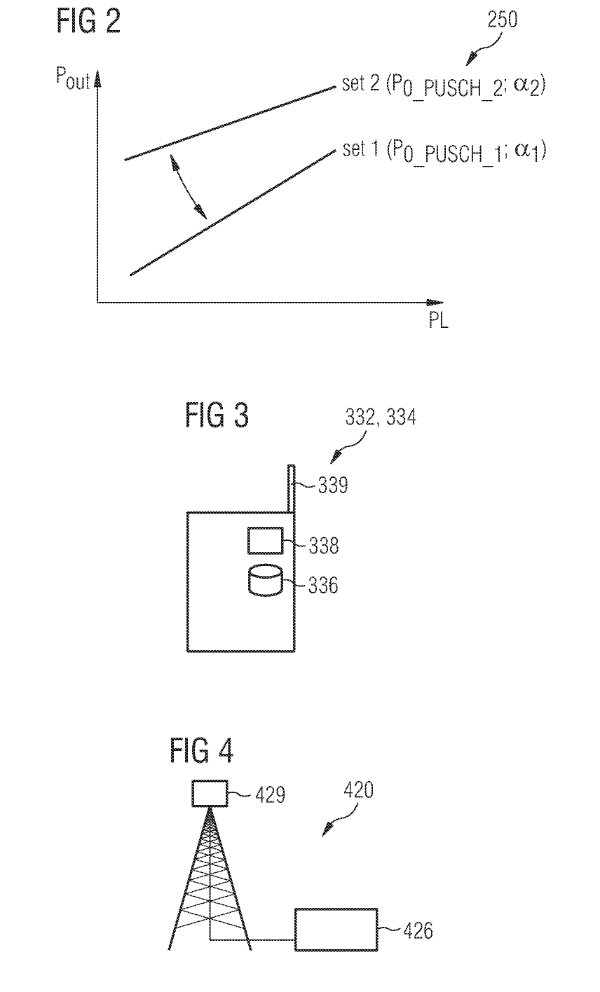

FIG. 2 shows a diagram 250 illustrating the dependency of the transmitting power P_{OUT} of a network element from a pathloss PL between the network element and the serving base station. A first set set1 comprising values P₀_{_{—}}_{PUSCH}_{_{—}}₁ and α₁ represents a so called conservative power control parameter set, whereas a second set set2 comprising values P₀_{_{—}}_{PUSCH}_{_{—}}₂ and α₂ represents a so called aggressive power control parameter set. In this respect an aggressive set of power control parameters is characterized by strongly compensating a pathloss of radio signals propagating from the transmitting network element to the receiving base station. Accordingly, the conservative set of power control parameters is characterized by compensating the pathloss only weakly. Also, in general, when using the aggressive set the network element will transmit with a higher transmission power on average than when using the conservative set.

It has to be mentioned that in the embodiment described so far it has been assumed that each TTI has only a single pair of power control parameters being valid for all of its physical resource blocks (PRBs). However, it has to be mentioned that the power control parameter pairs such as P₀_{_{—PUSCH}}/α pairs could also be linked to specific sets of PRBs. For instance, an upper half (e.g. PRB#0 . . . 24) of available PRBs can be associated with aggressive power control settings, whereas the lower half (PRB#25 . . . 49) of the available PRBs can be associated with more conservative settings. Of course, thereby there might still be a cross talk problem, but this problem will predominantly be limited to the boundary PRBs #24/#25.

In particular for a rather wide band radio transmission channel of say 20 MHz it may be possible to define two cell subareas that can use different power setting, because enough attenuation of a spill over from another subarea to this subarea is possible. In this case it is possible to assign the two sets of power control parameters to the two subareas.

Further, it is mentioned that the above described split of the radio transmission resource in the time and the frequency domain could also be combined. More generally, it is possible to assign a specific set of power control parameters to a predefined area in the time-frequency domain i.e. to a set of PRBs, which could be divided in the frequency or in the time direction.

At this point it is further mentioned that as the orthogonality between adjacent PRBs may be poor, instead of switching between the two sets of power control parameters from one PRB to the next PRB it may be better to more gradually change the settings. E.g. the parameter P₀_{_{—}}_{PUSCH} may be changed linearly between the values of the two sets on a range of intermediate PRBs, the same may apply for the above described slope parameter α.

Depending on the specific implementation it may be the case that the leakage between different subcarriers is different depending on how far they are spaced apart in frequency. This is not the case if the non-orthogonality is caused by a limited Analog-Digital-Converter resolution. However, this may be the case if there are frequency shifts (the 1/x part of the relevant sinc function reduces the cross talk due to frequency shifts) a fortiori the further the PRBs are separated from each other. Therefore, as a further variant the power control parameters can be not changed simply linearly, but taking this 1/x behavior into account i.e. the power difference (or the difference in power control settings) grows in accordance with this 1/x behavior. This may provide the advantage that the parameters can be set as aggressive as possible, whereby those cross talks are kept within a predefined level.

FIG. 3 shows a network element 332, 334, which is adapted to accomplish the above described transmission power control method. According to the embodiment described here the network element is a user equipment (UE) 332, 334.

The UE 332, 334 comprises a memory 336 for storing the first set of power control parameters and the second set of power control parameters. Further, the UE 332, 334 comprises a transmission unit 338, which is adapted to use (a) the first set of power control parameters for transmitting within the first radio transmission resource and (b) to use the second set of power control parameters for transmitting within the second radio transmission resource.

Further, the UE 332, 334 comprises an antenna 339 for transmitting the power controlled radio signals to a serving base station and for receiving radio signals from the serving base station. If the Network element is a Relay node rather than a UE, it will have additional functionality and elements to also communicate with the subordinate UEs, but these are out of scope for this invention.

FIG. 4 shows a base station 420, which is adapted to prompt a user equipment (UE) and/or a relay node to accomplish the described transmission power controlling method when transmitting radio signals to the base station 420.

The base station 420 comprises a unit 426 for providing a first set of power control parameters and a second set of power control parameters to at least one network element. The provision of the power control parameters can be carried out in such a manner that (a) the first set of power control parameters and the second set of power control parameters are stored within a memory of the network element, (b) the first set of power control parameters are used by the network element for transmitting within a first radio transmission resource and (c) the second set of power control parameters is used by the network element for transmitting within a second radio transmission resource.

Further, the base station 420 comprises an antenna 429 for receiving the power controlled radio signals from a network element being served by the base station 420 and for transmitting radio signals to the served network element.

It should be noted that the term “comprising” does not exclude other elements or steps and “a” or “an” does not exclude a plurality. Also elements described in association with different embodiments may be combined. It should also be noted that reference signs in the claims should not be construed as limiting the scope of the claims.

The above described transmitting power control method and the devices, which are adapted to carry out this method, may be provide for the following advantages:
Strong network elements being located close to the base station can achieve higher peak rates.
The slope parameter a being indicative for the fractional pathloss compensation can be chosen more conservative. Therefore, radio signals originating from weak network elements, which are for instance located far away from the base station, have a smaller risk of drowning in strong radio signals.
The overall performance of a cellular telecommunication network can be increased without signaling the value for P₀_{_{—}}_{PUSCH} and for α individually for each network element or even for each TTI. Therefore, the signaling overhead can be kept within acceptable limits.
The described solution is very flexible since the network elements are not constrained to use a particular P₀_{_{—}}_{PUSCH} and α settings. The fact that it is not necessary that the strong (close) network elements do have to avoid any TTIs leads to a trunking respectively a multiplexing gain.

Last but not least it is mentioned that the invention described in this application can also be used in a backward compatible way in particular for legacy user equipments (UEs) and/or legacy relay nodes: Legacy UEs and/or relay nodes typically only support a single set of (non-aggressive) power control parameters and are therefore only scheduled in the “low power TTIs”. By contrast thereto, new UEs and also new relay nodes are also scheduled in the “high power TTIs” using the alternate (aggressive) set of power control parameters. Legacy UEs in good positions can also be assigned to the aggressive set and are then scheduled in the high power TTIs. However, these legacy UEs can then only be scheduled in the high power TTIs, because they would use too much power in the low power TTIs and therefore they would make comparatively weak radio signals to drown in their comparatively strong radio signals.

### LIST OF REFERENCE SIGNS

100 cellular telecommunication network
110 cell
120 base station
132 first (strong) network element/first (strong) User Equipment/relay node
134 second (weak) network element/second (weak) User Equipment
250 diagram
P_{OUT} output transmitting power
PL pathloss
set1 first set of power control parameter
set2 second set of power control parameter
332, 334 network element/User Equipment
336 memory
338 transmission unit
339 antenna
420 base station
426 unit for providing power control parameter sets
429 antenna

1. Method for controlling the transmission power for a network element being connected to a base station of a cellular telecommunication network via an uplink wireless data connection, the method comprising
providing a first set (set1) of power control parameters (P₀_{_{—}}_{PUSCH}_{_{—}}₁, α₁) and a second set (set2) of power control parameters (P₀_{_{—}}_{PUSCH}_{_{—}}₂, α₂)
storing the first set (set1) of power control parameters (P₀_{_{—}}_{PUSCH}_{_{—}}₁, α₁) and the second set (set2) of power control parameters (P₀_{_{—}}_{PUSCH}_{_{—}}₂, α₂) within the network element,
using the first set (set1) of power control parameters (P₀_{_{—}}_{PUSCH}_{_{—}}₁, α₁) by the network element for transmitting within a first radio transmission resource, and
using the second set (set2) of power control parameters (P₀_{_{—}}_{PUSCH}_{_{—}}₂, α₂) by the network element for transmitting within a second radio transmission resource.

2. The method as set forth in claim 1, wherein the first set (set1) and/or the second set (set2) is a predefined set of power control parameters.

3. The method as set forth in claim 1, wherein the first set (set1) of power control parameters and/or the second set (set2) of power control parameters includes a value (P₀_{_{—}}_{PUSCH}_{_{—}}₁, P₀_{_{—}}_{PUSCH}_{_{—}}₂) being indicative for the signal power offset received by the base station.

4. The method as set forth in claim 1, wherein the first set (set1) and/or the second set (set2) of power control parameters includes a slope parameter (α₁, α₂) for a fractional pathloss compensation.

5. The method as set forth in claim 1, wherein the first radio transmission resource is a first time slot and/or the second radio transmission resource is a second time slot.

6. The method as set forth in claim 1, wherein
the transmission power for a plurality of network elements being assigned to a cell of the cellular telecommunication network is controlled and
the first set (set1) of power control parameters (P₀_{_{—}}_{PUSCH}_{_{—}}₁, α₁) is used by the plurality of network elements for transmitting within the first radio transmission resource, and
the second set (set2) of power control parameters (P₀_{_{—}}_{PUSCH}_{_{—}}₂, α₂) is used by the plurality of network elements for transmitting within the second radio transmission resource.

7. The method as set forth in claim 6, wherein providing the first set (set1) of power control parameters (Pₒ_{_{—}}_{PUSCH}_{_{—}}₁, α₁) and the second set (set2) of power control parameters (P₀_{_{—}}_{PUSCH}_{_{—}}₂, α₂) comprises signaling the first set (set1) and/or the second set (set2) of power control parameters to the plurality of network elements on a common radio channel.

8. The method as set forth in claim 6, wherein in answer to a change of a condition for transmitting radio signals
a usage of the first set (set1) of power control parameters (Pₒ_{_{—}}_{PUSCH}_{_{—}}₁, α₁) is associated with a first change of the transmitting power of the network element and
a usage of the second set (set2) of power control parameters (P₀_{_{—}}_{PUSCH}_{_{—}}₂, α₂) is associated with a second change of the transmitting power of the network element, wherein the first change is smaller than the second change.

9. The method as set forth in claim 8, wherein
the plurality of network elements comprises a first group of first network elements and a second group of second network elements, wherein each one of the first network elements has a better radio connection with the base station as each one of the second network elements, and wherein
the first radio transmission resource is allocated predominantly to the first network elements, and
the second radio transmission resource is allocated predominantly to the second network elements.

10. The method as set forth in claim 8, wherein
the plurality of network elements comprises a first group of first network elements and a second group of second network elements, wherein each one of the first network elements has a better radio connection with the base station as each one of the second network elements and wherein
the first radio transmission resource is exclusively allocated to the first network elements and
the second radio transmission resource is allocated to all network elements of the plurality of network elements.

11. The method as set forth in claim 1, further comprising
providing at least a further set of power control parameters,
storing the further set of power control parameters within the network element, and
using the further set of power control parameters by the network element for transmitting within a further radio transmission resource.

12. A network element for a cellular telecommunication network, the network element comprising
a memory for storing a first set (set1) of power control parameters (P₀_{_{—}}_{PUSCH}_{_{—}}₁, α₁) and a second set (set2) of power control parameters (P₀_{_{—}}_{PUSCH}_{_{—}}₂, α₂), and
a transmission unit, which is adapted
to use the first set (set1) of power control parameters (Pₒ_{_{—}}_{PUSCH}_{_{—}}₁, α₁) for transmitting within a first radio transmission resource, and
to use the second set (set2) of power control parameters (Pₒ_{_{—}}_{PUSCH}_{_{—}}₂, α₂) for transmitting within a second radio transmission resource.

13. The network element as set forth in claim 12, wherein the network element is a user equipment or a relay node of the cellular telecommunication network.

14. A base station for a cellular telecommunication network, the base station comprising a unit for providing a first set (set1) of power control parameters (P₀_{_{—}}_{PUSCH}_{_{—}}₁, α₁) and a second set (set2) of power control parameters (P₀_{_{—}}_{PUSCH}_{_{—}}₂, α₂) to at least one network element in such a manner that
the first set (set1) of power control parameters (P₀_{_{—}}_{PUSCH}_{_{—}}₁, α₁) and the second set (set2) of power control parameters (Pₒ_{_{—}}_{PUSCH}_{_{—}}₂, α₂) are storable within a memory of the network element,
the first set (set1) of power control parameters (P₀_{_{—}}_{PUSCH}_{_{—}}₁, α₁) is usable by the network element for transmitting within a first radio transmission resource and
the second set (set2) of power control parameters (P₀_{_{—}}_{PUSCH}_{_{—}}₂, α₂) is usable by the network element for transmitting within a second radio transmission resource.

15. A computer program for controlling the transmission power for a network element being connected to a base station of a cellular telecommunication network via an uplink wireless data connection, the computer program, when being executed by a data processor, is adapted for controlling the method as set forth in claim 1.
